(19) United States
(12) Patent Application Publication
(10) Pub. No.: US 2009/0213069 A1
(43) Pub. Date: Aug. 27, 2009

(54) ELECTRONIC APPARATUS AND METHOD OF CONTROLLING ELECTRONIC APPARATUS

(75) Inventor: Hiroyuki Kusaka, Mitaka-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/236,403

(22) Filed: Sep. 23, 2008

(30) Foreign Application Priority Data
Feb. 25, 2008 (JP) 2008-043110

(51) Int. Cl. G06F 3/033

(52) U.S. Cl. 345/157

(57) ABSTRACT

According to one embodiment, an electronic apparatus includes: a sensor portion configured to detect an input by touch; a button portion provided in a vicinity of the sensor portion; a first switch portion provided correspondingly to the button portion and configured to detect an input in response to press-down of the button portions; a second switch portion provided correspondingly to the sensor portion and configured to detect an input in response to press-down of the sensor portion; and a sensor control portion configured to control an input detecting operation at the sensor portion while both the first switch portion and the second switch portion detect the input.

### CROSS-REFERENCE TO RELATED APPLICATIONS

This application is based upon and claims the benefit of priority from Japanese Patent Application No. 2008-043110, filed on Feb. 25, 2008, the entire contents of which are incorporated herein by reference.

### BACKGROUND

1. Field

One embodiment of the invention relates to an electronic apparatus and more particularly to an electronic apparatus including a touch pad unit.

2. Description of the Related Art

Some electronic apparatuses such as a personal computer of a portable type include a touch pad unit. For example, a personal computer of a notebook type (hereinafter referred to as a “notebook PC”) includes a display portion having an LCD and a body portion having a keyboard and a touch pad, and can confirm information input from the keyboard and the touch pad through the display portion. In particular, the touch pad can freely change a position of a cursor over a display screen. Therefore, the touch pad is often used together with a keyboard input.

The touch pad has an input portion. It is possible to freely move the cursor of the display portion in accordance with a track of a movement of a finger by touching the input portion with the finger. Some apparatuses can optionally vary to set a sensitivity of the input portion through the touch pad. In general, the setting is often carried out in such a manner that the input portion detects an input to the touch pad through a slight touch of the finger itself over the input portion.

Since the touch pad serves as an input device together with the keyboard, it is often disposed close to the keyboard, more specifically, in the vicinity of the keyboard on a near side to be an inputting person side from the keyboard. Also in some cases in which a user originally wants to carry out an input through the keyboard, accordingly, a finger of the user touches the touch pad despite the intention of the user. In other words, there is caused a so-called “input error (false input)” in which the cursor is moved to a place of which the user is not conscious during a key input in some cases. JP-A-10-198507 has disclosed a structure in which a switch is disposed under the touch pad and is turned ON/OFF through a vertical motion of a touch panel face of the touch pad (see JP-A-10-198507, page 3 and FIG. 1, for instance).

In the structure disclosed in JP-A-10-198507, however, a degree of force to be applied to the touch pad is varied depending on users. Also in the case in which the ON/OFF operation of the switch is not intended, the touch panel carries out the vertical motion. For this reason, a false input may be generated in the ON/OFF operation of the switch.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an electronic apparatus according to an embodiment of the invention;

FIG. 2 is an exemplary side view showing a casing provided in the computer of FIG. 1, a part of which is taken away;

FIG. 3 is an exemplary view for explaining a switch input of the computer according to the embodiment;

FIG. 4 is an exemplary view for explaining the switch input of the computer according to the embodiment;

FIG. 5 is a block diagram for explaining an example of a structure of a computer 1;

FIG. 6 is a block diagram for explaining an example of an internal structure of an EC/KBC 50; and

FIG. 7 is an exemplary flowchart showing a method of switching an input of a touch pad according to the embodiment.

### DETAILED DESCRIPTION

Various embodiments according to the invention will be described hereinafter with reference to the accompanying drawings. In general, according to one embodiment of the invention, an electronic apparatus includes: a sensor portion configured to detect an input by a touch; a button portion provided in a vicinity of the sensor portion; a first switch portion provided correspondingly to the button portion and configured to detect an input in response to press-down of the button portions; a second switch portion provided correspondingly to the sensor portion and configured to detect an input in response to press-down of the sensor portion; and a sensor control portion configured to control an input detecting operation at the sensor portion when both the first switch portion and the second switch portion detect the input.

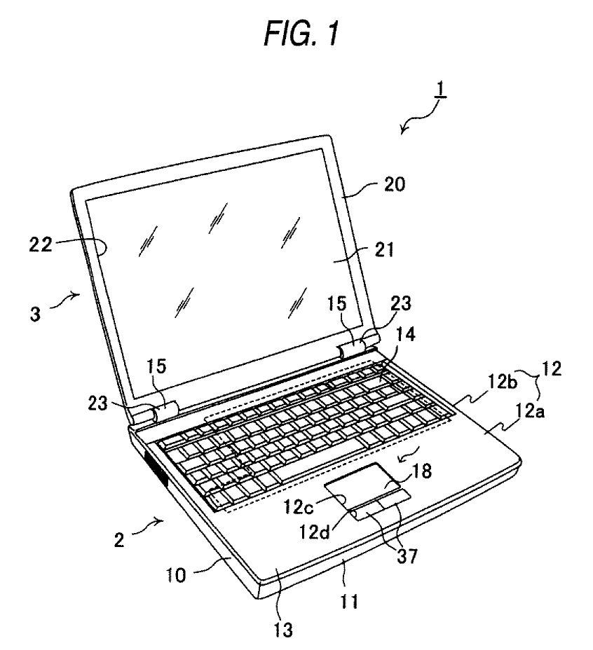

A first embodiment according to the invention will be described below with reference to FIGS. 1 to 4 illustrating an application to a computer serving as an electronic apparatus.

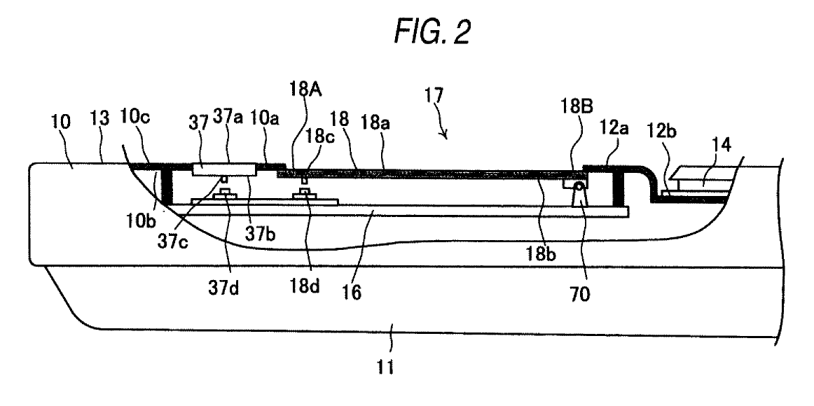

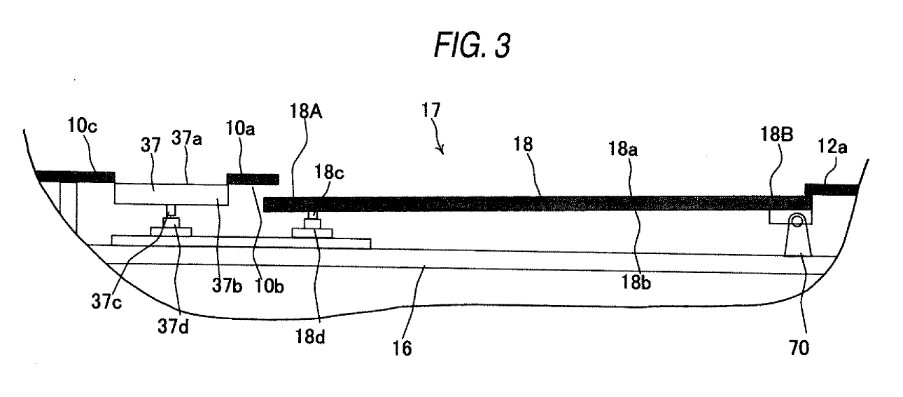

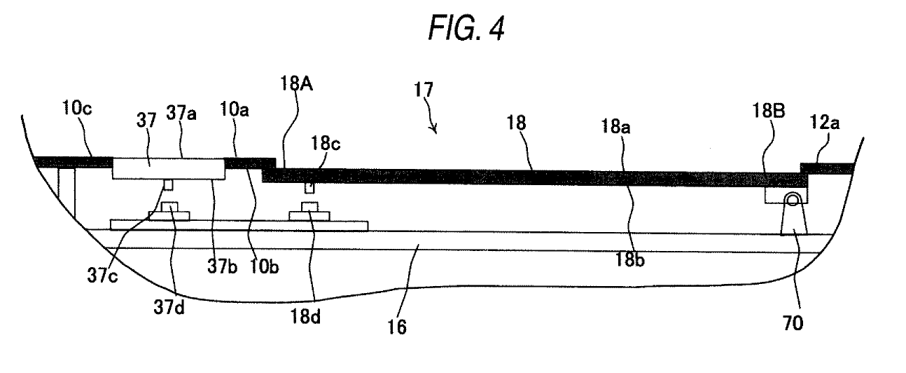

FIG. 1 is an exemplary perspective view showing an electronic apparatus according to the embodiment of the invention. FIG. 1 illustrates a computer 1 of a notebook type. FIG. 2 is an exemplary side view showing a casing provided in the computer of FIG. 1, a part of which is taken away. FIGS. 3 and 4 are exemplary views for explaining a switch input of the computer according to the embodiment. The computer 1 includes an apparatus body 2 and a liquid crystal display unit 3.

The apparatus body 2 has a casing 10 formed by a resin. The casing 10 has a case 11 and a cover 12 and is formed to shape as a flat box. An external wall 10c of the casing 10 configured of the case 11 and the cover 12 has an external face 10a which is exposed outward from the casing 10.

The cover 12 has a first cover 12a and a second cover 12b. An external face exposed outward from the first cover 12a has a palm rest 13. The second cover 12b is disposed behind the first cover 12a and a keyboard 14 is attached to the second cover 12b. Although the cover 12 is configured of a plurality of members (the first cover 12a and the second cover 12b) in the embodiment, it may be formed of a single member. A pair of display supporting leg portions 15 is provided apart from each other in a transverse direction of the casing 10 at a rear end of the second cover 12b.

The liquid crystal display unit 3 has a display casing 20 and an LCD 21 accommodated in the display casing 20. An opening portion 22 for a display is provided on a front wall of the display casing 20. The opening portion 22 has a size over most part of the front wall and a display screen of the LCD 21 is exposed outward from the display casing 20 through the opening portion 22.

The display casing 20 has a pair of coupling recess portions 23 on one of ends thereof. The coupling recess portions 23 are constituted by dents opened forward, downward and rearward from the display casing 20. The coupling recess portions 23 are disposed apart from each other in a transverse direction of the display casing 20 and are led to the leg portions 15 of the casing 10, respectively. The coupling recess portions 23 are rotatably supported on a rear end of the casing 10 through a hinge fixture (not shown), respectively.

For this reason, the liquid crystal display unit 3 is swingable between a closing position in which it is brought down to cover the palm rest 13 and the keyboard 14 from above and an opening position in which it is erected to expose the palm rest 13 and the keyboard 14. FIG. 1 shows the computer 1 in the opening position.

As illustrated in FIGS. 1 and 2, a main board (shown in a dotted line of FIG. 1), a touch pad 17 to be a pointing device serving as an HDD 48 input device (not shown in FIGS. 1 and 2), and a printed wiring board 16 for the touch pad 17 are accommodated in the casing 10.

The printed wiring board 16 and the HDD 48 are screwed into the casing 10.

The touch pad 17 has an input sheet 18 and a driving device (not shown). The touch pad 17 is electrically connected to the main board in the casing 10. The input sheet 18 serves to detect an electrostatic capacity, for example, and one of faces serves as a flat input face 18a.

The driving device is electrically connected to the input sheet 18.

The input sheet 18 is accommodated in the casing 10 in a state in which an edge part is overlaid on an internal face 10b of the casing 10, for example, an internal face of the first cover 12a. The first cover 12a of the cover 12 is provided with an opening portion 12c for the touch pad 17. The opening portion 12c is a size smaller than the input sheet 18 and the input face 18a of the input sheet 18 is exposed outward from the first cover 12a through the opening portion 12c.

The input sheet 18 has ends 18A and 18B. At the end 18B, a support mechanism 70 is provided on a face 18b side to be a face at an opposite side to the input face 18a. The support mechanism 70 has one of ends which is rotationally supported on the face 18b through a rotating spring, for example. The other end of the support mechanism 70 is fixed to the printed wiring board 16. The end 18A is provided in contact with a lower face of the casing 10 around the opening portion 12c.

A projecting portion 18c is provided on the face 18b at the end 18A side in the input sheet 18. A switch (a second switch) 18d is provided on the printed wiring board 16 in an opposed position to the projecting portion 18c. The second switch 18d is provided in a central part in a transverse direction of the input sheet 18, for example. The second switch 18d serves to detect an input corresponding to press-down of the input sheet 18.

With the structure, the input sheet 18 can be rotated around the end 18B and at least a certain pressure is applied to give an input to the second switch 18d. More specifically, when the pressure is applied to the input face 18a, the input sheet 18 carries out a rotating motion around the end 18B so that the end 18A is tilted at a certain angle. If a high pressure is applied to the input sheet 18, the projecting portion 18c comes in contact with the second switch 18d (FIG. 3) so that the second switch 18d detects the input. On the other hand, when the pressure is eliminated, the end 18A is tilted in a reverse direction and the input sheet 18 is returned into a horizontal state because the support mechanism 70 is supported by the rotating spring (FIG. 4).

A button 37 is provided along an opening portion 12d. More specifically, the opening portion 12d is a size larger than the button 37 and an input face 37a of the button 37 is exposed outward from the first cover 12a through the opening portion 12d. The button 37 is elastically supported (not shown). For example, the button 37 is moved downward when a pressure is applied to the input face 37a (FIG. 3), and the button 37 is returned into an original position when the pressure is eliminated (FIG. 4).

A projecting portion 37c is provided on a face 37b of the button 37. A switch (a first switch) 37d is provided on the printed wiring board 16 in an opposed position to the projecting portion 37c. The first switch 37d serves to detect an input corresponding to press-down of the button 37.

The first switch 37d and the second switch 18d may be mounted on the same small substrate, and the small substrate may be mounted on the printed wiring board 16.

By setting the touch pad 17 to have the structure, the touch pad 17 can be input through a movement of a finger of a user over the input sheet 18, and furthermore, can be input the second switch 18d by pressing the input sheet 18. Consequently, it is possible to switch the input of the touch pad 17 while both the first switch 37d and the second switch 18d detect the input.

(Method of Controlling Computer)

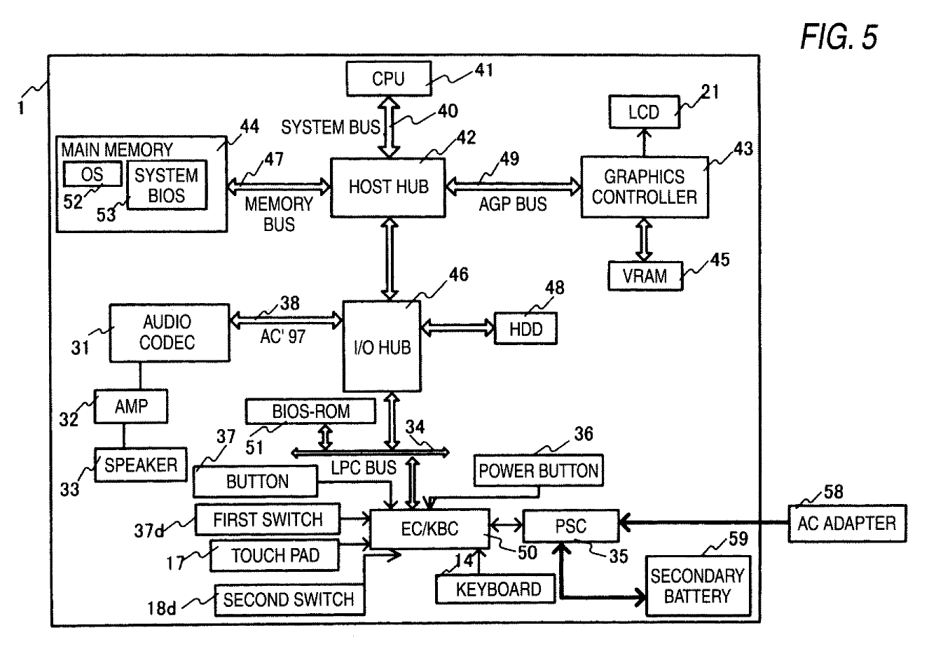

Next, a method of controlling the computer, more specifically, a method of switching the input of the touch pad 17 will be described with reference to FIGS. 5 to 7. FIG. 5 is a block diagram for explaining an example of the structure of the computer 1.

A CPU 41, a main memory 44, an I/O (Input/Output) hub (a second bridge circuit) 46 are connected to a host hub (a first bridge circuit) 42.

The host hub 42 is connected to the CPU 41 via a system bus 40. The host hub 42 includes a memory controller for controlling an access to the main memory 44.

The CPU 41 is a main processor for controlling an operation of the computer 1. The CPU 41 executes an operating system (OS) 52, an application program and a utility program which are loaded onto the main memory 44 through a memory bus 47 from the HDD 48 to be an external storage device. Moreover, the CPU 41 executes a Basic Input Output System (System BIOS) 53 loaded onto the main memory 44 from a BIOS-ROM 51.

A graphics controller 43 connected to the host hub 42 through an Accelerated Graphics Port (AGP) bus 49 outputs a digital display signal to the LCD 21. A video memory (VPAM) 45 is connected to the graphics controller 43, and the graphics controller 43 displays, on the LCD 21, data drawn to the video memory 45 in accordance with the OS/application program.

The I/O hub (the second bridge circuit) 46 connected to the host hub 42 through a dedicated bus such as a hub interface controls each device on a low pin count(LPC) bus 34.

The BIOS-ROM 51 is connected to the LPC bus 34. The BIOS-ROM 51 stores a program such as the System BIOS 53.

The I/O hub 46 is connected to the HDD 48 to be an external storage device which serves to support serial ATA standards through a serial ATA bus for supporting the serial ATA standards, for example.

The HDD 48 stores data generated by using the operating system (OS) 52, the application program, the utility program and the application program.

An audio codec 31 is connected to the I/O hub 46 through an Audio Codec (AC) 97 (38). The audio codec 31 is a kind of a sound inputting/outputting codec. The audio codec 31 has a codec portion of a sound to be input/output.

An AMP 32 is connected to the audio codec 31. The AMP 32 serves to amplify a sound signal generated in the audio codec 31. The sound signal amplified by the AMP 32 is sent to a speaker 33, and the speaker 33 outputs a sound wave in an audio frequency band.

An embedded controller/keyboard controller IC (EC/KBC) 50 is connected onto the LPC bus 34.

The EC/KBC 50 is a one-chip microcomputer in which an embedded controller for carrying out a power management and a keyboard controller for controlling the keyboard 14 are integrated.

The keyboard 14, a power button 36, the input sheet 18 to be the pointing device, the button 37, the switch for the touch pad (the first switch 37d), the switch for the button (the second switch 18d) and a Power Supply Controller (PSC) 35 are connected to the EC/KBC 50. Furthermore, an AC adapter 58 and a secondary battery 59 are connected to the PSC 35.

The computer 1 can set a validity/invalidity for a data inputting operation corresponding to a manipulation of the input sheet 18 or the button 37 through a user. For example, when the user sets the invalidity for the data inputting operation corresponding to a manipulation for pressing the touch pad 17 and the button at the same time, the data inputting operation corresponding to the manipulation of the input sheet 18 is prevented from being carried out also in the case in which the user singly manipulates the touch pad 17.

The EC/KBC 50 receives a signal input with the manipulation of the keyboard 14, the input sheet 18 and the button 37. The EC/KBC 50 transmits the received signal to the CPU 41. The signal is processed by the CPU 41 and a result of the processing is displayed on the LOD 21. For example, when the touch pad 17 is manipulated, a pointer displayed on the LCD 21 is moved.

The PSC 35 supplies a power fed from the AC adapter 58 or the secondary battery 59 to each module in the computer 1. The secondary battery 59 is provided exchangeably. In the case in which the power is supplied from the AC adapter 58 to the computer 1, the power supplied from the AC adapter 58 is stored in the secondary battery 59 through the PSC 35.

When the user manipulates the power button 36, the EC/KBC 50 detects that the power button 36 is manipulated. When the EC/KBC 50 detects that the power button 36 is manipulated, it gives the PSC 35 a notice for starting the supply of a power to the system of the computer 1, for example. The PSC 35 carries out a control to start the supply of the power from the AC adapter 58 or the secondary battery 59 to the system of the computer 1 based on the notice given from the EC/KBC 50.

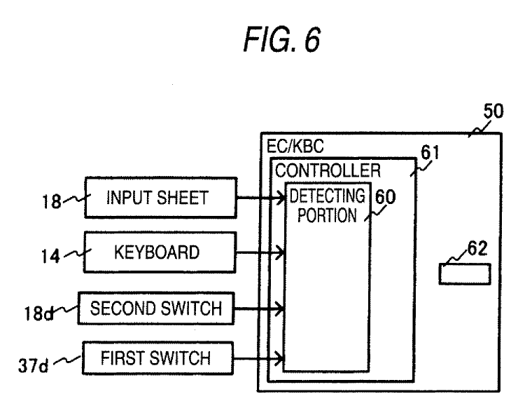

Next, description will be given to an example of an internal structure of the EC/KBC 50. FIG. 6 is a block diagram for explaining the example of the internal structure of the EC/KBC 50.

The EC/KBC 50 includes a controller 61. Moreover, the controller 61 includes a detecting portion 60. Furthermore, the EC/KBC 50 has a register 62.

The detecting portion 60 detects a signal corresponding to the manipulation of each of the touch pad 17 and the button 37.

The controller 61 refers to and changes a value of the register 62 in response to the signal detected by the detecting portion 60.

Next, description will be given to setting related to a data inputting operation corresponding to the manipulation of the touch pad 17. For convenience of a position in which the touch pad 17 is provided, in some cases, the user manipulates the input sheet 18 unintentionally by a palm of a hand, for example. In these cases, a data input might be generated through the manipulation of the keyboard 14 in a different cursor position from a position intended by the user although the user desires only the data input through the manipulation of the keyboard 14 in a certain cursor position.

In order to eliminate the drawback, there is carried out setting for switching the validity/invalidity of the data input through the manipulation of the input sheet 18 in the touch pad 17 in case of an execution of both the input of the second switch 18d through the press-down of the input sheet 18 and the press-down of the first switch 37d through the press-down of the button 37.

The “case of an execution of both the press-down of the first switch 37d and the input of the second switch 18d” includes the case in which the inputs of the first switch 37d and the second switch 18d are detected at the same time, and furthermore, the case in which the input of only one of the switches is detected and the case in which the input of the - 14 other switch is then detected within a certain time. It is also possible to employ a structure in which the certain time can be changed to be set by using utility software.

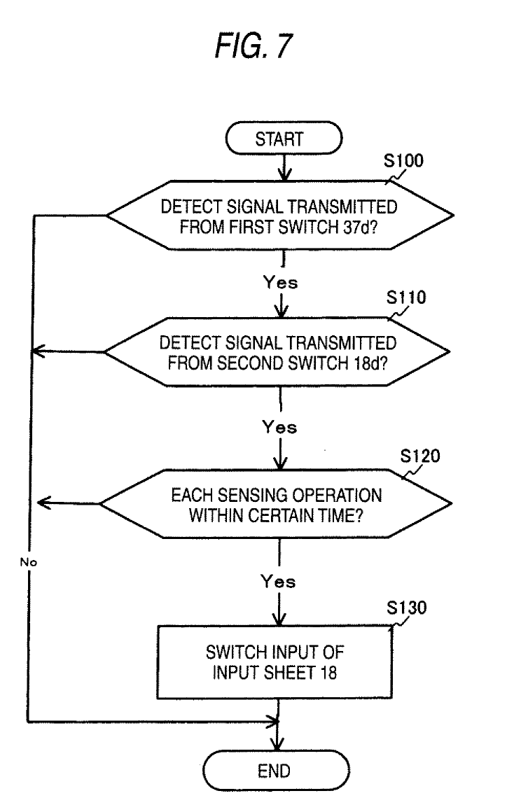

FIG. 7 is a flowchart showing a method of switching an input of a touch pad according to the embodiment of the invention.

The detecting portion 60 decides whether a signal indicating that the first switch 37d is pressed down in response to the press-down manipulation of the button 37 is received or not (Step S100) As a result, if the detecting portion 60 does not receive the signal indicating the press-down of the first switch 37d (No in Step S100), the operation of the processing is ended.

On the other hand, if the detecting portion 60 receives the signal indicating the press-down of the first switch 37d (Yes in Step S100), the detecting portion 60 then decides whether a signal indicating that the second switch 18d is pressed down in response to the press-down manipulation of the touch pad 17 is received or not (Step S110).

As a result, if the detecting portion 60 does not receive the signal indicating the press-down of the second switch 18d (No in Step S110), the operation of the processing is ended.

On the other hand, if the detecting portion 60 receives the signal indicating the press-down of the second switch 18d (Yes in Step S110), a difference in an input time for a signal between the first switch 37d and the second switch 18d is calculated by the controller 61 and whether a certain time is not exceeded is decided (Step S120). As a result, if it is decided that the certain time is exceeded (No in Step S120), the operation of the processing is ended.

On the other hand, if it is decided that the certain time is not exceeded (Yes in Step S120), the input of the input sheet 18 is switched (Step S130). The input switching is carried out by referring to and changing a value of the register 62 through the controller 61. More specifically, if the value of the register 62 is set to be a value for causing the input of the input sheet 18 to be valid, it is changed to be a value for causing the input of the input sheet 18 to be invalid. To the contrary, if the value of the register 62 is set to be the value for causing the input of the input sheet 18 to be invalid, it is changed to be the value for causing the input of the input sheet 18 to be valid.

The input switching for the touch pad 17 is carried out as described above. In other words, the controller 61 always transmits the input of the input sheet 18 to the CPU 41 in consideration of the value of the register 62. If the controller 61 decides that the value of the register 62 is the value for causing the input of the input sheet 18 to be invalid, it does not transmit the input of the input sheet 18 to the CPU 41. On the other hand, if the controller 61 decides that the value of the register 62 is the value for causing the input of the input sheet 18 to be valid, it transmits the input of the input sheet 18 to the CPU 41. The invention is not exactly restricted to the embodiment but can be implemented by changing components without departing from the scope in an executing stage. By a proper combination of the components disclosed in the embodiment, moreover, it is possible to form various inventions. For example, some of all the components described in the embodiment may be deleted. Furthermore, it is also possible to properly combine components in a different embodiment.

What is claimed is:

1. An electronic apparatus comprising:
a sensor portion configured to detect an input by a touch;
a button portion provided in a vicinity of the sensor portion;
a first switch portion provided correspondingly to the button portion and configured to detect an input in response to a press-down of the button portions;
a second switch portion provided correspondingly to the sensor portion and configured to detect an input in response to a press-down of the sensor portion; and
a sensor control portion configured to control an input detecting operation at the sensor portion when both the first switch portion and the second switch portion detect the input.

2. The electronic apparatus of claim 1, wherein the control of the input detecting operation in the sensor control portion comprises switching whether the input detecting operation at the sensor portion is executed or not.

3. The electronic apparatus of claim 1, wherein the second switch portion is provided in a central part in a transverse direction of the sensor portion.

4. The electronic apparatus of claim 3, wherein the first switch portion and the second switch portion are mounted on same substrate.

5. A method of controlling an electronic apparatus comprising a sensor portion configured to detect an input by a touch, a button portion provided in a vicinity of the sensor portion, a first switch portion configured to detect an input in response to press-down of the button portion, and a second switch portion configured to detect an input in response to press-down of the sensor portion, comprising:
detecting an input at the first switch portion;
detecting an input at the second switch portion; and
controlling an input detecting operation at the sensor portion when both the first switch portion and the second switch portion detect the input.

6. The method of claim 5, wherein controlling the input detecting operation at the sensor portion comprises switching whether the input detecting operation at the sensor portion is executed or not.
